(19) United States
(12) Patent Application Publication
(10) Pub. No.: US 2022/0379354 A1
(43) Pub. Date: Dec. 1, 2022

(54) MACHINE FOR CLEANING A SECTION OF PIPELINE

(71) Applicant: PIPELINE INDUCTION HEAT LTD., Burnley (GB)

(72) Inventors: Damian DAYKIN, Lancashire (GB); Christopher MCCORMACK, Burnley (GB); Nicholas HOLLAND, Burnley (GB)

(21) Appl. No.: 17/817,103

(22) Filed: Aug. 3, 2022

Related U.S. Application Data
(63) Continuation of application No. 14/960,699, filed on Dec. 7, 2015, now abandoned.

(30) Foreign Application Priority Data
Dec. 8, 2014 (GB) 1421792.1

(51) Int. Cl. B08B 9/023; B24C 3/06; B24C 3/32; B08B 13/00; B05C 11/00

(52) U.S. Cl. CPC B08B 9/023; B24C 3/06; B24C 3/32; B08B 13/00; B05C 11/00; B08B 2209/02

(57) ABSTRACT

A pipeline field joint abrasive blast cleaning machine is disclosed in which direct contact between the pipe to be cleaned and drive rollers of the machine ensure a constant, known distance exists between the blast nozzles of the machine and the pipe surface. This ensures uniform application of abrasive matter to ensure uniform cleaning of the pipe surface.

### CROSS-REFERENCE TO RELATED APPLICATIONS

This application is a continuation of U.S. patent application Ser. No. 14/960,699, filed Dec. 7, 2015, which claims priority from UK Patent Application No. GB1421792.1, filed Dec. 8, 2014, the disclosure of which is incorporated herein by reference in its entirety.

### FIELD OF THE INVENTION

The present invention relates to pipe cleaning machines arranged to blast a region of a pipe presented to the machines for cleaning with abrasive and has particular, although not exclusive relevance to such machines as are employed on lay barges constructing and laying pipelines at sea.

### BACKGROUND OF THE INVENTION

Oil, gas and other pipelines are typically formed from multiple lengths of individual steel pipe sections that are welded together end-to-end as they are being laid. As used herein, a section of pipeline is any length of a pipeline construction whilst a pipe section is what is welded to other pipe sections to form the pipeline. To prevent corrosion or other damage to the pipe sections occurring both from the environment and during transportation, or to reduce heat loss of fluids transported by pipelines, the pipe sections are coated with one or more protective and/or insulation layers. The pipe sections are usually externally coated at a factory remote from the location in which they are to be laid. This is often referred to as factory-applied coating and it is generally more cost effective than coating pipe sections on site where they are laid. At the factory, the coating is applied to the outside of the pipe sections whereupon a short length of approximately 150 mm to 250 mm is left uncoated at either end of the pipe section.

A factory-coating may take several different forms depending on the particular coating specification. A conventional coating will typically comprise at least a first, or ‘primer’, layer, such as a fusion bonded epoxy (FBE) material that is applied to the outer surface of the steel pipe section while it is being heated. To ensure a good bond between the steel pipe section and the primer layer, the pipe section is typically blast cleaned with an abrasive, such as iron or steel grit to clean the surface and generate an appropriate anchor pattern. The pipe section is heated, before the primer layer is applied, to what is normally the curing temperature of the powdered primer material. On contact with the heated pipe section surface the primer material coalesces and cures to form a continuous layer. The primer layer mainly protects against corrosion. The primer layer may be used as the sole layer in a coating or it may be supplemented with additional layers to provide additional mechanical protective or thermal insulation properties.

Polypropylene, polyethylene, and polyurethane material have good mechanical protective and thermal insulation properties and they are commonly used to coat pipelines transporting fluids at temperatures up to 140° C. Polypropylene, polyethylene and polyurethane are widely used in factory-applied coating for pipe sections. While curing of the primer layer is ongoing, and so as to allow the layers to bond, a second layer of polypropylene, polyethylene or polyurethane coating is commonly applied. All but the ends of the pipe section is enclosed by a heavy duty mould that defines a cavity around the uncoated pipe section, which is subsequently filled with polyurethane material from a specialized metering and mixing machine. Once the second layer has at least partially cured and solidified, the mould is removed to leave the factory-applied coating in place on the pipe section. Alternatively external layers of polypropylene or polyurethane may be applied over the primer layer by a variety of methods including cross head and side extrusion.

Optionally, if polypropylene is used as the second layer in the coating, an additional layer of chemically modified polypropylene (CMPP) material which acts as an adhesive may be applied between the primer layer and second layer during the curing time (i.e. time taken to harden or set) of the primer layer. Likewise, if polyethylene is used as the second layer in the coating, an additional layer of polyethylene material which acts as an adhesive may be applied between the primer layer and second layer during the curing time of the primer layer.

Optionally, when it is desired to reduce the buoyancy of the pipeline for subsea applications an additional weight coating may be applied over the coating layers described above. Such a coating may be formed by a layer of concrete at a thickness specified to give the desired negative buoyancy. The concrete may be molded or sprayed onto the pipe. When concrete coating is applied a portion at each end of the pipe remains uncoated. The length of the section that remains free of weight coating is usually longer than that which is left bare of the corrosion and insulation coatings. Therefore a portion of the pipeline coating will protrude beyond the weight coating at each pipe end.

The uncoated ends are necessary to enable the pipe sections to be welded together to form a pipeline in the field, which may be at sea on a lay barge, for example. A section of pipeline where the ends of adjacent pipe sections are joined by welding is known as a field joint. After welding, the exposed ends of the steel pipe sections on either side of the weld (i.e. the field joint) must also be coated in order to either protect the field joint, or to inhibit chemical degradation, or both. Field joint coatings may be applied using techniques similar, or equivalent, to the factory-applied coating techniques. Field joint coatings may be applied using a variety of systems which may incorporate an FBE primer layer under a heat shrinkable sleeve or other protective layer. Where appropriate, thicker insulating coatings may be applied to field joints, typically comprising molded polyurethane or polypropylene layers. Where the pipeline coating system includes a concrete weight coating layer an additional infill will often be applied across the space in the weight coating at the field joint comprising, the infill material may be a high density polyurethane foam which is molded in place, the mould may remain in place when the pipe is laid. The infill material provides some protection to the underlying layers of the field joint coating and provides the completed pipeline with a substantially continuous outside diameter which assists in the passage of the pipeline over rollers as it passes off the lay barge and into the sea.

Polypropylene, polyethylene or polyurethane coatings are frequently applied in relatively thin layers (typically 3-8 mm thick) for mechanical protection, thicker coatings (typically 50-150 mm) are used for thermal insulation. Where the thicker layers are applied the concentricity of the coating relative to the steel pipe is often not closely controlled, whereas the thinner coatings used for mechanical protection generally exhibit good concentricity. Thick insulating coatings are usually applied with a short section of a thinner layer close to the exposed steel to facilitate the application of an overlapping field joint coating system and this thinner layer generally has good concentricity. Concrete weight coatings do not generally provide a thinner layer close to the exposed steel and do not generally exhibit good concentricity.

The field joints and field joint coatings should have, as far as is possible, the same mechanical and thermal properties as the rest of the pipeline. Thus, a field joint section of pipeline should be properly prepared prior to coating. Preparation of a field joint section of pipeline may involve cleaning the field joint after welding so that it is, as far as is possible, as clean as when it was originally blast cleaned in the factory. In certain environments, such as at sea on a lay barge, it is often the case that the field joint section of the pipeline, once welded, suffers from being dirty or having surface contaminants thereon. Before any field joint coating can be applied, it is necessary to clean the joint surface back to clean bare metal so that the applied coating is chemically and structurally sound and adheres to the metal surface for the life of the pipeline's intended use. It is known to prepare a field joint section of pipeline for coating by cleaning it manually by operators using hand-held power wire brushes. This process is time-consuming and labour-intensive. Manual cleaning does not reliably clean the entire surface area of the field joint. This is important because any debris remaining on the field joint can adversely affect the subsequent coating process and degrade the mechanical and thermal properties of the field joint coating. Frequently the use of abrasive blasting is employed to achieve cleaning of the pipeline field joint surface prior to coating application. If automated, the blasting process tends to yield more reliable and repeatable results than manual cleaning.

One example of a known automated abrasive process and apparatus for achieving this is shown in EP-1,750,902-A. The machine and process described employs a saddle formed from two inverted U-shaped yolks separated by a plurality of bars designed to extend longitudinally of a pipe to be blasted. Coupled to each yolk is a circular rotatable frame and the bars connect the frames together. Mounted on the bars are the blast nozzles. On actuation of motors connecting each yoke to its respective rotatable frame, the frame rotates about the pipe and, hence the nozzles also. The method of cleaning the pipe is to move the nozzles (by use of further motors) along the bars in the axial direction of the pipe and then to return to the original position. Subsequent indexing of the rotatable frame occurs by a few degrees and then the next longitudinal “out and back” sweep of the nozzles occurs. This process continues until the pipe surface has been sufficiently cleaned.

This process and apparatus has drawbacks, however. In particular, as the saddle is formed form yokes which are mounted directly to the pipe surface and the blast nozzles hang from bars coupled to the rotatable frame, there is no direct correlation between the external surface contours of the pipe and the separation therefrom of the nozzles. This means that, as the nozzles move over the pipe surface (whether longitudinally or circumferentially), their distance from the pipe surface may vary. With no mechanism disclosed as to how the operator or the machine may vary the output of the nozzles dependent upon their separation from the pipe surface, the propensity for an uneven abrasive cleaning action of the pipe surface exists. Not only is the use of a saddle problematic in causing separation of the nozzle movement form the surface contours of the pipe, but the saddle yokes are clamped rigidly to the pipe during the cleaning operation. This exacerbates the problem of the nozzles not being able to follow accurately any surface contours in the pipe. This is because rotation of the frame about the pipe via the yokes is truly circular, yet the outer circumferential periphery of any given pipe may not exhibit a true circle. Even if the outer periphery of the pipe is circular, any coating applied to the pipe's outer surface (on which coating the saddle sits) may not be. Thus the propensity for the nozzles not to accurately follow the outer surface topography upon which the saddle is mounted exists.

Furthermore to place the saddle upon a pipeline using the system described in EP-1,750,902-A requires significant overhead clearance. This may be problematic in a situation such as on a lay barge, where space is limited.

### BRIEF SUMMARY OF THE INVENTION

It is an object of the present invention to at least alleviate the abovementioned shortcomings by providing a pipe cleaning machine arranged to blast a region of a pipe presented to the machine for cleaning with abrasive in order to remove dirt or contaminants from the surface of the pipe prior to application to the pipe surface of a protective coating, the machine including:

a cage member formed in a plurality of parts and for enclosure thereby of a pipe to be cleaned, each part of the plurality of cage member parts being moveably coupled to each of the other parts of the plurality of cage member parts;

a plurality of motion imparters, each motion imparter of the plurality of motion imparters being coupled to the cage member;

at least one abrasive blast means, the or each at least one blast means formed on one or more of the plurality of cage member parts, the machine characterised by

each motion imparter of the plurality of motion imparters being arranged for direct contact with the pipe to be cleaned, or a coating thereon, when the pipe to be cleaned is enclosed by the cage member,

and wherein movement of the plurality of motion imparters when the pipe is enclosed by the cage member causes rotation of the cage member around the enclosed pipe;

and by further including indexing means for moving the at least one abrasive blast means longitudinally relative to a pipe presented to the machine for cleaning.

By arranging for direct contact between the pipe presented for cleaning and the motion imparters, then, as the cage member rotates about the pipe, because the abrasive blast means are formed on one or more of the plurality of cage member parts, the abrasive blast means will accurately follow the surface contours of the pipe periphery. This permits of maintaining a known separation of the abrasive blast means form the pipe surface, thus ensuring accurately known and controlled repeatable cleaning quality of the pipe.

Preferably the plurality of parts of the cage member are pivotally coupled to each other. This enables the cage member to be easily opened to accept a pipe to be cleaned and then to easily be close to enclose the pipe therewithin. Such operation permits of rapid setting and removal of the cage form around a pipe, thus reducing wasted time during a cleaning operation. Furthermore, by employing a system utilising pivotal coupling, there is no longer a need for any significant overhead clearance to be provided above the pipeline in order for the machine to be lowered into place and lifted clear of the pipeline, unlike in the prior art.

In a preferred embodiment each of the plurality of motion imparters comprises a drive roller. Use of rollers around the pipe ensures a small area of contact between the machine and the pipe, thus enhancing the accuracy with which the abrasive blast means follow the surface topography of the pipe during their movement therearound.

Advantageously each part of the plurality of cage member parts carries at least one motion imparter. This provides for the ability to spread the rotatable force between the pipe and the cage to be evenly spread around the cage for accurate control of cage movement.

Additionally, or alternatively, the machine may further include a restraint guide arranged to be rigidly coupled to the pipe enclosed by the cage member and wherein the cage member rotates around the restraint guide on actuation of the plurality of motion imparters. This aids accurate tracking of movement of the cage around the pipe.

### BRIEF DESCRIPTION OF THE DRAWINGS

An embodiment of the present invention will now be described, by way of example only and with reference to the accompanying drawings, of which:

FIG. 1 illustrates schematically a pipeline and its field joint;

FIG. 2 shows an isometric perspective view of a machine in accordance with the present invention;

FIG. 3 shows a schematic side view of the machine of FIG. 2;

FIG. 4 shows schematically an end view of the cage of FIGS. 2 and 3 in the open position about a pipe presented thereto;

FIG. 5 shows schematically an end view of the cage of FIG. 4 in the closed position about a pipe presented thereto;

FIG. 6 shows an isometric perspective view of a nozzle used in the machine of the present invention;

FIG. 7 illustrates schematically the wheel assembly viewed from above;

FIG. 8 illustrates schematically a rear view of the wheel assembly of FIG. 7;

FIG. 9 illustrates schematically a side view of the wheel assembly of FIG. 7;

FIG. 10 shows an isometric perspective view of the wheel assembly of FIG. 7;

FIG. 11 illustrates schematically a side view of the restraint guide used in the machine of the present invention;

FIG. 12 shows a side view rotated through 90° as compared to the view of FIG. 11;

FIG. 13 shows an isometric perspective view of the restraint guide of FIGS. 11 and 12;

FIG. 14A shows an isometric perspective view of the machine of the present invention and FIG. 14B shows a restraint guide in situ on a pipe for cleaning;

FIG. 15 shows a schematic side section through a machine in accordance with the present invention (but without the guide restraint present) encapsulating a pipe presented thereto for cleaning with two nozzles in the 3 and 9 o'clock positions;

FIG. 16 shows the view of FIG. 16, but with the cage rotated through 90° to be in the 6 and 12 o'clock positions;

FIG. 17 shows a schematic illustration of the machine in accordance with the present invention in operation.

### DETAILED DESCRIPTION OF THE INVENTION

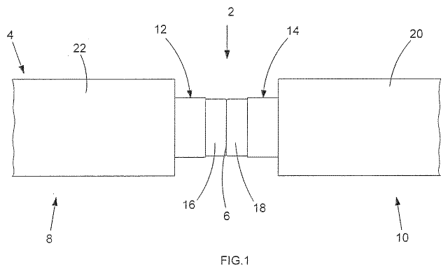

Referring firstly to FIG. 1, a field joint 2 of a pipeline, shown generally at 4 is illustrated. The field joint, as explained above, is at the welded joint 6 of two pipes 8, 10. It can be seen that the pipes 8, 10 have each already been coated as shown at 12, 14. Also, the bare pipe regions 16, 18 are visible either side of the weld joint 6. Because the pipeline illustrated in this embodiment is intended to be laid sub-sea, the sections of pipeline, except for the field joint 2, are coated with a weighting/protection compound, here concrete 20, 22. The concrete 20, 22 coating serves the dual purpose of weighting the pipeline so that, as it departs the lay barge it readily submerges and also the concrete offers barrier protection to the pipeline against, for example, trawling or anchor damage when at rest on the sea bed.

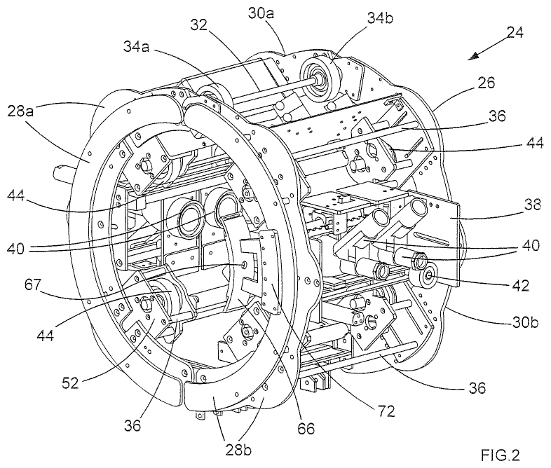

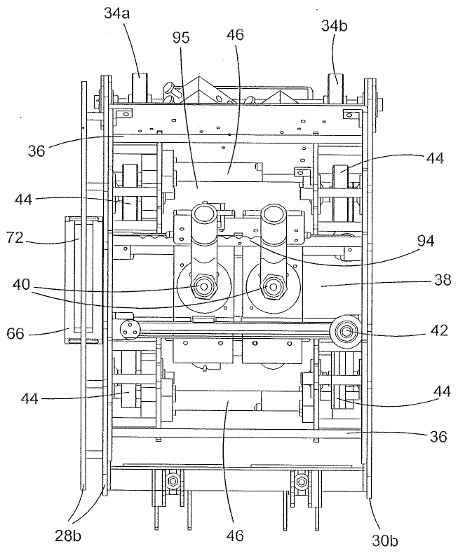

FIGS. 2 and 3 show the pipe cleaning machine 24 used to blast abrasive (whether dry air-propelled abrasive, such as sand or water-carried abrasive) at the exposed surfaces 16, 18 of the field joint 2. The machine 24 comprises a cage member 26 formed from a plurality or parts, in this example being two sets of pivotally articulated arms 28a, 28b and 30a, 30b. The arms 28 are both pivotally coupled at their upper ends to arms 30 via an automatic closing means, in this example hinge mechanism 32. The hinge mechanism includes a cylindrical bar having which operatively couples together rotatable wheels 34a and 34b at each end thereof. The hinge mechanism 32 permits each arm 28a, 30a to pivot relative to its respective other arm 28b, 30b in order to enclose therewithin a pipe presented to the machine for cleaning, as will be explained further below. The term enclose means that the arms 28, 30 of the cage member 26 are able to surround (whether partially or wholly) the pipe presented to the machine at least to such a degree as to allow the machine 24 to achieve its cleaning function. Whilst this preferably entail the cage member 26 arms 28, 30 totally surrounding the pipe 50 presented to the machine 24, completely surrounding the pipe 50 may not be necessary.

Arm 28a is connected to arm 30a not only via the hinge mechanism 32, but also by a set of longitudinally extending support bars 36. Similarly, arm 28b is connected to arm 30b. The support bars 36 serve not only to separate the arms 28 from the arms 30, but also provide a first, longitudinal, guide rail structure supporting an abrasive blast means, here a blast head assembly 38 which accommodates an abrasive blast nozzle. In this example two such nozzles 40 are provided. Between, or during, blast cleaning operations, the assembly 38 moves, under the control of drive belt 42, longitudinally (ie to the left and right of FIG. 3) so as to indexingly move the blast assembly to the next longitudinal section of pipe to be cleaned. In this manner, therefore, indexing means is provided to achieve this movement. It can be seen that in this example, two sets of blast assemblies 38 are provided in diametrically opposed alignment. Whilst this is preferable, it is not essential. Only one nozzle 40 could be employed, but more nozzles makes the cleaning operation more efficient.

A plurality of motion imparters, here drive rollers 44 are coupled to the cage member arms 28, 30. The rollers 44 are driven by respective drive motors, in this case compressed air motors 46. When the rollers 44 are in contact with the surface of a pipe presented to the cage member 26 and is enclosed thereby (see below), actuation of the air motors 46 causes rotation of the rollers 44 such that the whole cage member 26 will rotate about the pipe. If, as the cage member 26 rotates about the pipe, the blast nozzles 40 are operating, then circumferential cleaning of the pipe surface will be achieved. Assuming the entire circumferential periphery of the pipe is to be cleaned, the blast nozzles are both (although not necessarily concomitantly)

rotated around the pipe and translated along the axial extent of the filed joint 2 in order to ensure complete cleaning of the field joint 2 surface. This dual operation (rotation around the pipe and longitudinal translation axially along it) may be achieved by any appropriate combination of the two movements. They may be independent of each other, or combined. This is a matter of choice for the operator of the machine 24.

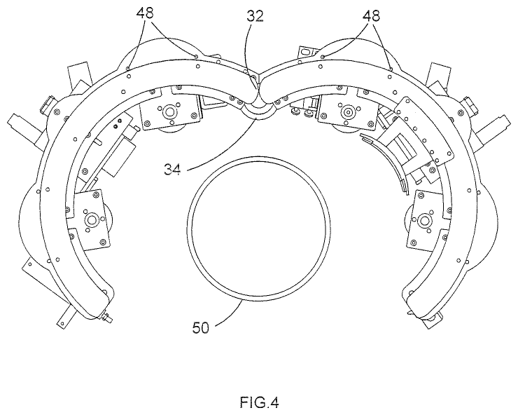

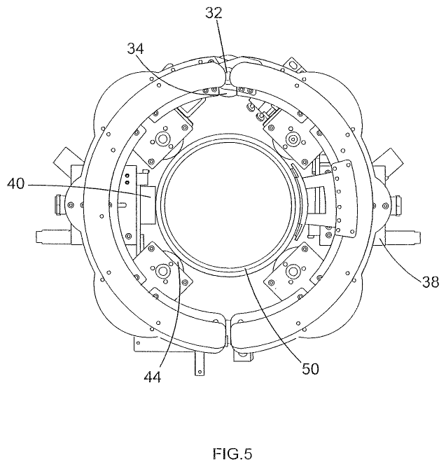

Referring now also to FIGS. 4 and 5, encapsulation of a pipe presented for cleaning will be described. It can be seen from FIG. 4 that the cage member 26 must first be opened about the hinge mechanism 32 so that the arms 28, 30 are splayed apart. This opening operation is achieved by use of pulleys (not shown) acting on the eyelets 48 of each arm 28, 30 in known manner. The open cage member 26 is then lowered into position over the pipe 50 presented for cleaning. It can be seen that in the open state, the cage member 26 presents the rotatable wheels 34a, 34b first to the pipe 50. This means that, on lowering the cage member 26 onto the pipe 50, the first contact between the two is via the rotatable wheels 34a, 34b. Continued lowering of the cage member 26 causes the arms 28, 30 to pivot downwards about the wheels 34a, 34b and the cylindrical bar of the hinge mechanism 32 into the closed position shown in FIG. 5.

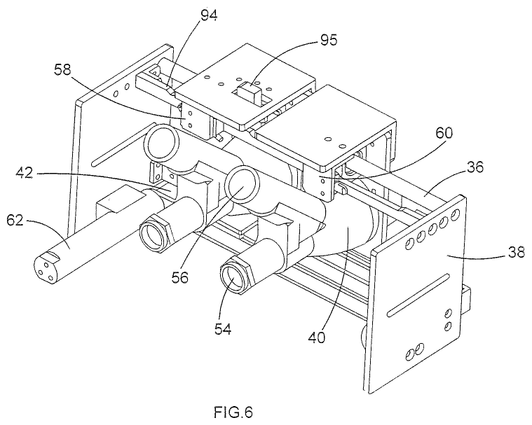

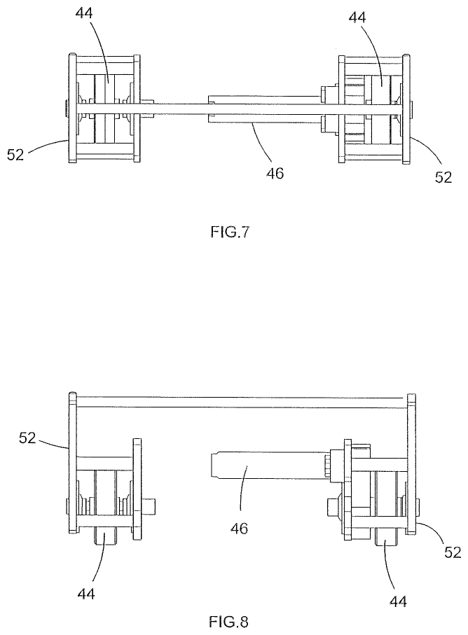

When in the closed position of FIG. 5, the cage member 26 encloses the pipe 50 so that the pipe can be cleaned. It will be seen that in this closed position, the hinge mechanism 32 is now proud of the pipe 50 upper surface and, importantly, the drive rollers 44 are in direct contact with the surface of the pipe coating 50. The drive rollers sit within adjustable mounting plates 52 (see FIGS. 7-10) so that different pipe 50 diameters may be accommodated within the cage member 26 and ensuring that the drive rollers 44 are in direct contact with the pipe surface.

One significant benefit of having the drive rollers 44 in direct contact with the surface coating of the pipe 50 is to maintain the blast nozzles 40 at a constant, known distance from the pipe 50 surface. As the blast assembly 38 and associated nozzles 40 travel around the circumferential periphery of the pipe 50, any topography undulations in the coating surface will be directly followed by the drive rollers 44 and, therefore also the nozzles 40. This is because the nozzles 40 are part of the blast assembly 38 and the blast assembly 38 is coupled directly to the arms 28, 30 of the cage member 26. Maintaining a constant distance between the nozzles 40 and the pipe 50 surface during operation of the machine 24 ensures accurate control of the

rate and concentration of grit/abrasive material application to the pipe 50 surface. Having the drive rollers 44 in contact with and directly following the contours of the pipe 50 field joint coating provides an accurate tracking of the surface contours of the pipe 50 surface itself, because application of the pipe coating itself follows any pipe surface contours. However, it is possible for the drive rollers to sit directly on the pipe 50 surface, if wanted. This is possible due to the adjustability of the drive rollers, as will be explained below.

The blast assembly is shown in detail at FIG. 6 wherein the two nozzles 40 each comprise, in known manner, an application port 54 and a vacuum exit port 56. The principles of a blast abrasive applicator, such as nozzles 40 which supply grit or abrasive material under pressure to a surface to be cleaned and then remove it along with the abraded material under vacuum is well known. For example, the Vacu-Blast (trade name) gun disclosed in Blast Cleaning and Allied Processes, Volume 1 by H J Plaster, 1972 may be employed in the present invention. Those skilled in the art understand the principles of operation of such a gun and so its operation will not be described herein. However, as has been explained above, the longitudinal indexing of the assembly 38 along the length of the pipe 50 is achieved by moving the assembly along the support bar 36 in fixed increments. This incremental movement is governed by the profile of a control cam 94. In order to avoid overtravel of the assembly 38, end position sensors 58, 60 are used to sense the limits of this longitudinal travel. Movement of the drive belt 42 is governed by air motor 62 under the control of a central processing unit, not shown. The indexing means in this example, therefore, includes not only the drive belt 42 and associated motor 62, but also the end position sensors 58, 60, control cam 94 and associated cam switch 95, all of which work in unison to control the indexing movement of the assembly 38. The control cam 94 and cam switch 95 of the assembly 38 provide independent, positive, feedback to the central processing unit to ensure that movement of the nozzles 40 of the assembly 38 is accurately controlled regardless of any varying frictional forces between the nozzles 40 and the pipe 50, or any varying performance of the air motor 62.

The central processing unit is a computer control mechanism for the operation of the machine. An operator is able to enter various cleaning parameters into the unit so that the entire cleaning operation is automated and requires minimal human intervention. This enables more accurate cleaning of the pipe surface than if left to human control. However, the machine must know where the cage member 26 is in relation to the pipe 50 at all times. To achieve this, a datum, or reference, position needs to be known as a starting, end or return position.

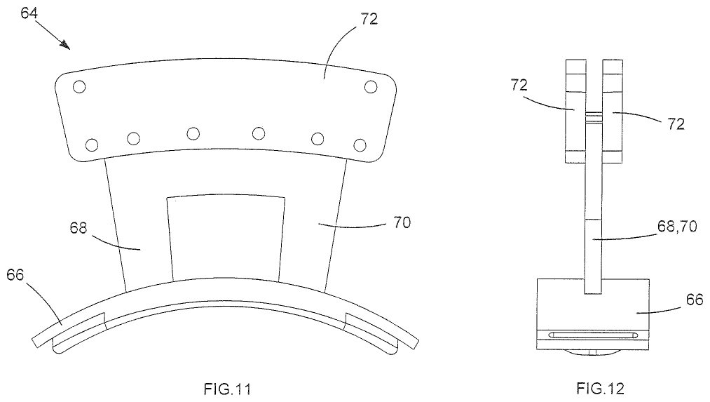

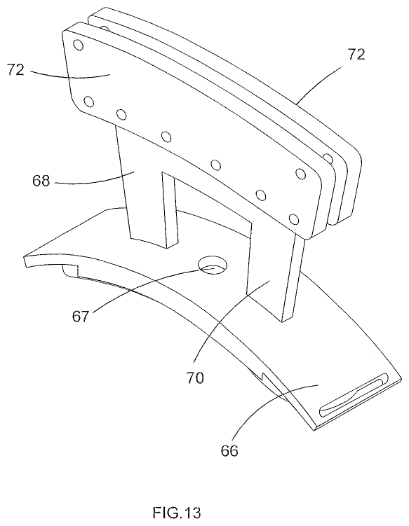

FIGS. 11-13 show a restraint guide, here a vacuum restraint 64. The restraint comprises an arcuate shoe 66 with a port 67 (FIG. 13) formed therein for coupling to a vacuum hose. Depending from the shoe 66 are two support arms 68, 70 which couple the shoe to a split guide 72. The port 67 is utilised to connect a vacuum hose (not shown) thereto in order to immovably hold the vacuum restraint 64 immovably to the pipe 50 surface. Use of a vacuum clamping mechanism is convenient, as a vacuum is already used in operation of the machine 24 in as the return part of the nozzle 40 operation. Whilst there will need to be different and separate vacuum hoses, a common vacuum source can be provided, thereby creating operating efficiencies. However, any other means of securing the restraint guide to the pipe 50 surface may be employed, such as magnetic clamping, ratchet straps or webbing or the like. The essential requirement is that the restraint guide be immovably clamped to the pipe 50 surface thereby to enable a reference, or datum position to be established for the machine 24.

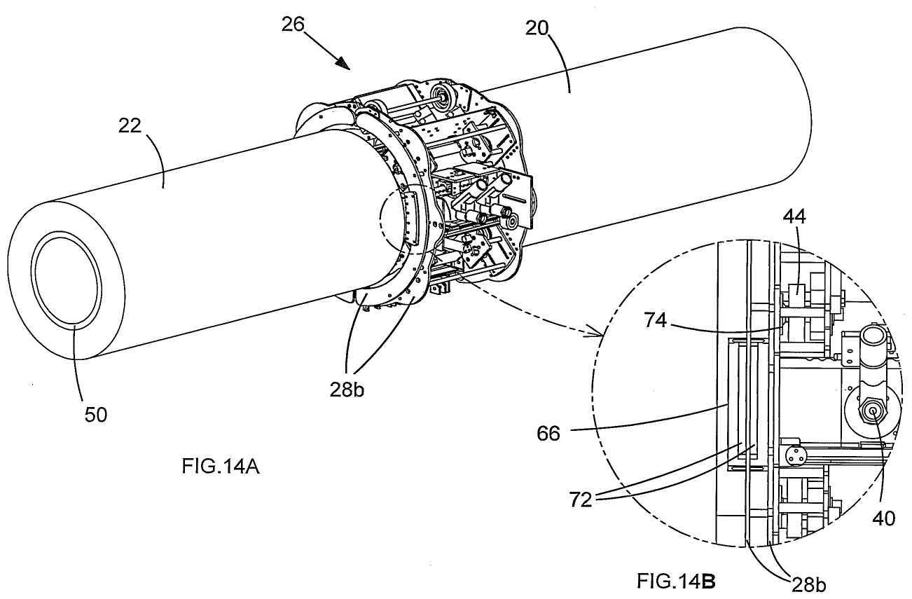

Reference now also to FIG. 14 shows how the vacuum restraint 64 cooperates with the cage member 26 to establish a reference position for the machine 24. FIG. 14a shows a general perspective view of the cage member 26 mounted on the field joint of the pipe 50 to be cleaned and FIG. 14b shows a detailed view of the coupling thereof between the vacuum restraint 64 and the arm 28b of the cage member 26. The split guide 72 of the vacuum restraint 64 flanks either side of the left hand part of the arm 28b. The vacuum restraint 64 is immovably clamped to the pipe 5. Upon actuation of the drive rollers 44, the cage member 26 will rotate about the field joint circumference, yet will not be able to move longitudinally along the pipe (i.e. along the axis of the pipe 50), due to the vacuum restraint 64 preventing any movement of the arm 28b other than circumferential rotation. Furthermore, the interaction of the arm 28b with the split guide 72 allows start and finish datum or reference positions to be calculated by the central processing unit and used to control the rotation of the cage member 26 about the pipe 50 field joint 2. To achieve this, sensors 74 are located on the cage member 26 adjacent the drive rollers 44 and the split guide 72. In known manner, these sensors 74 provide known reference or datum points, from which all angular rotation amounts of the cage member are known. The angular alignment of the sensors 74 between the cage member 26 and split guide 72 provides the start (0°) and finish (180°) points (in this example) for rotation of the cage member 26. Those skilled in the art will appreciate that use of the vacuum restraint 64 is not necessary, but only preferable. The machine 24 is able to rotate around the pipe 50 under action of the drive roller 44 alone and could sit directly on the pipe 50 surface axially between any pipe 50 coating. The pipe 50 coating could itself act to establish a reference position for the rotation of the cage member 26 around the pipe.

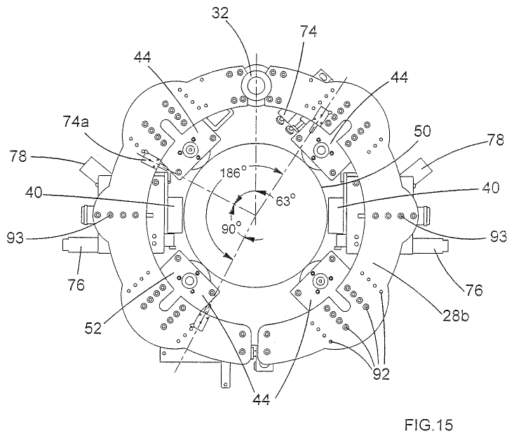

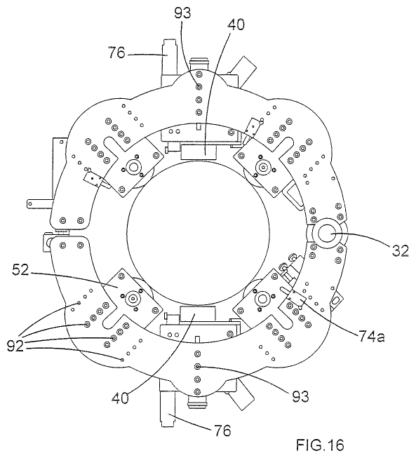

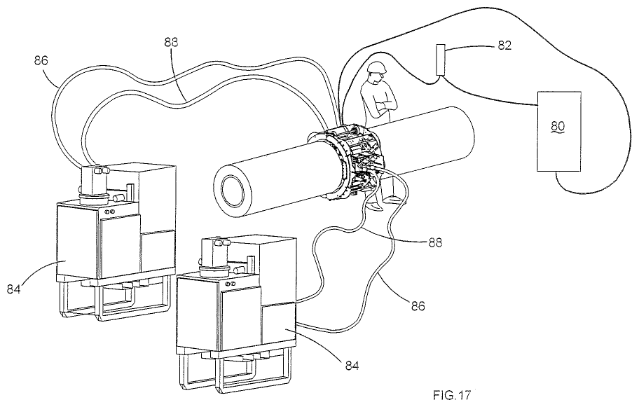

Operation of the machine 24 is explained now with reference also to FIGS. 15 and 16. In FIG. 15 the machine 24 is in its initial, or at rest position. Here the cage member 26 has been lowered into position around the pipe 50 field joint and is also in place with respect to the vacuum restraint (not shown in FIGS. 15 and 16). Although not shown, an RFID switch cooperates with the hinge 32 of the cage member 26 in order to provide a positive indication of the arms 28, 30 having moved to their closed position with the pipe 50 thereby enclosed by the cage member 26. This indication is sent to the central processing unit before operation of the machine 24 may commence. The nozzle assemblies 38 are aligned horizontally in the 3 and 9 o'clock positions. This means that the central processing unit receives a signal form the home sensor 74a setting the initial reference or datum position. Sensors 74 and 74a interact with the vacuum restraint 64.

On actuation of the machine 24, compressed air (or water, or other fluid depending on the circumstances of the operation) is mixed with abrasive or grit material for cleaning and supplied to the nozzles 40 via supply ports 76. Concomitantly, the blasted fluid/abrasive is removed from the assemblies 38 after blasting the surface of the pipe 50 via vacuum ports 78, in known manner. As the blasting operation via the nozzles 40 commences, rotation of the cage member 26 around the pipe 50 also needs to commence. In the current example, this is achieved by actuation of the drive rollers 44 such that the cage member 26 rotates about the pipe 50 in a controlled manner at a known angular rate (again, in a way known to those skilled in the art) until the cage has rotated through the necessary angle (in this example, sets of 180°). FIG. 16 shows the cage member 26 having rotated anticlockwise through 90° such that the nozzles 40 are in vertical alignment at the 12 and 6 o'clock positions, respectively as compared to FIG. 15. It needs to be remembered that all ports 76, 78 are connected to high-pressure hoses and so movement of the entire machine 24 is often unwieldy. Thus, movement of the cage member from the FIG. 15 position to the FIG. 16 position is simply to set the zero, or initial datum reference point. Once in this zero position, the sets of 180° rotations may commence, interleaved in any appropriate manner by indexing of the longitudinal translation along the axial length of the field joint 2 by movement of the blast assembly 38. The cage member 26 thus rotates now alternately clockwise and anticlockwise, each time through 180° so as not to cause kinking or wrapping of the high pressure hoses attached to the ports 76, 78.

Each 180° rotation is detected by sensors 74 which govern the reversal of the sense of rotation of the cage member 26. Indexing of the blast assembly 38 in the axial direction of the pipe 50 (longitudinally), in this example, occurs as the nozzle 40 reaches the 12 or 6 o'clock position and the sensor 74 detects this extreme of the rotation. So, just as the cage member 26 starts to rotate again for 180°, but in the opposite sense, the axial travel has already occurred, or is in the process of being completed. And so this process goes on until the whole (or whatever portion thereof) of the field joint 2 surface has been cleaned.

FIG. 17 shows an illustrative example operation of the above process. The central processing unit 80 communicates data read from various machine 24 sensors (including sensors 58, 60, 74) to the machine operator's display pendant 82 so that parameters of the cleaning process can be monitored, controlled or changed in known manner. The grit/abrasive blast and recovery machines 84 each supply, via supply hose 86, compressed fluid and abrasive material to supply port 76 and remove the blasted material for subsequent recovery (in known manner) from the vacuum port 78 via recovery hose 88. Those skilled in the art will appreciate how the general principles of vacuum blasting operations such as the one briefly described above operate and so further reference thereto will not be made herein.

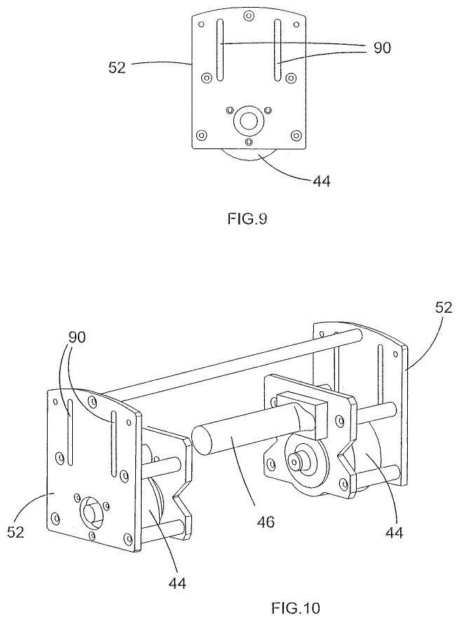

An important feature of the present invention is the ability of the machine 24 to operate with a variety of pipe 50 diameters and also with a variety of field joint 2 coating thicknesses. To this end each drive roller 44 is mounted on a radially adjustable mount 52 (see FIGS. 2, and 10 in particular), as has been mentioned above. Each mount includes radially extending slots 90 which cooperate with a plurality of mounting holes 92 formed in the arms 28, 30 of the cage member 26 (see FIGS. 15 and 16) so that the mount 52 may be set at an appropriate position relative to the surface of the pipe 50 in order to position the nozzles 40 at the desired

distance from that pipe 50 surface. In this manner, it can be ensured that the nozzles are held at a known, set distance from the surface of the pipe 50. As the assembly 38 and its respective nozzles 40 are held on the arms 28, 30 of the cage member 26 as it rotates about the pipe 50, any surface undulations felt by the rollers 44 during their rotation is imparted to the nozzles 40, hence keeping the distance from the nozzles to the surface of the pipe 50 constant, unlike the prior art. Furthermore, the blast assembly 38 is also adjustable so allow the operator to further control the attitude of the nozzles 40 in relation to the field joint surface (for example angle of inclination of the nozzles 40 to the surface of the pipe 50). In similar manner to adjustment of the drive rollers 44, as described above, the blast assembly 38 may also be moved radially by using mounting holes 93.

By employing a cage member 26 which itself rotates about a pipe 50 presented thereto for cleaning, unlike the prior art, the present invention does not require a stationary frame to straddle the pipe. This provides further advantages over simplification of design and use of less material in construction of the machine. One significant advantage of which is that the blast nozzles 40 of the machine 24 are able to accurately follow all surface contours of the pipe 50. In the case of the pipe 50 not being truly round, the nozzles are still maintained at a known distance from the pipe 50 surface. This enables an accurate blasting operation to be achieved which avoids the pitfalls of the prior art in which some area of the pipe surface may be over-blasted (if the pipe surface is too near the nozzles) or under-blasted (if the pipe surface is too far away from the nozzle).

Whilst in the above example driven rollers have been described as constituting the motion imparters, there are many alternative motion imparters which may equally be employed. The requirement of the motion imparter is to provide rotational motive force between the cage machine and the pipe presented thereto for cleaning. So tank tracks, wheels, linear reciprocating legs, hub and spoke mechanisms and the like are all equally efficacious. A restraining factor, however, is the need for the motion imparter to be in direct contact with either the pipe, the field joint coating surface or the factory applied coating adjacent the field joint area.

Although in the foregoing example the plurality of parts of the cage member 26 has been described as comprising generally two sets of arms 28, 30, coupled pivotally together at one hinge point 32, those skilled in the art will appreciated that this is not a limiting factor. If necessary, for reasons such as lack of available space in which to open the arms, or the like, it is required to utilise a plurality of parts articulated in more (or other) regions than one hinge joint, this is feasible within the scope of the present invention. For example, use of dual-hinged (or 3-part) arms may be employed to form the plurality of parts of the cage member. Whilst such a design may require moving of the hinge joint 32 and it's associated rotatable wheels 43 (or even replacement), this is within the capabilities of one skilled in the art.

1. A pipe cleaning machine arranged to blast a region of a pipe presented to the machine for cleaning with abrasive in order to remove dirt or contaminants from the surface of the pipe prior to application to the pipe surface of a protective coating, the machine including:
a cage member formed in a plurality of parts and for enclosure thereby of a pipe to be cleaned, each part of the plurality of cage member parts being moveably coupled to each of the other parts of the plurality of cage member parts;
a plurality of motion imparters, each motion imparter of the plurality of motion imparters being coupled to the cage member;
at least one abrasive blast means, the or each at least one blast means formed on one or more of the plurality of cage member parts, the machine characterised by: each motion imparter of the plurality of motion imparters being arranged for direct contact with the pipe to be cleaned, or a coating thereon, when the pipe to be cleaned is enclosed by the cage member,
and wherein movement of the plurality of motion imparters when the pipe is enclosed by the cage member causes rotation of the cage member around the enclosed pipe;
and by further including indexing means for moving the at least one abrasive blast means longitudinally relative to a pipe presented to the machine for cleaning.

2. The pipe cleaning machine of claim 1, wherein the plurality of parts of the cage member are pivotally coupled to each other.

3. The pipe cleaning machine of claim 1, wherein each of the plurality of motion imparters comprises a drive roller.

4. The pipe cleaning machine of claim 1, wherein each of the plurality of motion imparters is adjustable radially toward or away from the pipe to be cleaned.

5. The pipe cleaning machine of claim 1, wherein each part of the plurality of cage member parts carries at least one motion imparter.

6. The pipe cleaning machine of claim 1, further including a restraint guide arranged to be rigidly coupled to the pipe enclosed by the cage member and wherein the cage member rotates around the restraint guide on actuation of the plurality of motion imparters.

7. The pipe cleaning machine of claim 6, wherein the restraint guide provides a channel within which channel at least one of the plurality of parts of the cage member rotates.

8. The pipe cleaning machine of claim 1, wherein the at least one abrasive blast means comprises a vacuum-blast means.

9. The pipe cleaning machine of claim 8, wherein the vacuum-blast means comprises a vacuum blasting nozzle.

10. The pipe cleaning machine of claim 1, wherein the indexing means operates only when the at least one abrasive blast means is not being rotated by the cage member around the pipe presented to the machine for cleaning.

11. The pipe cleaning machine of claim 1, further comprising an automatic closing means arranged to close the cage member about the pipe presented thereto for cleaning thereby to enclose the pipe with the cage member.

12. A The pipe cleaning machine of claim 1, wherein the indexing means operates under control of sensor means.

13. The pipe cleaning machine of claim 12, wherein the sensor means provides positive feedback dependent upon movement of the indexing means.
